(19) United States
(12) Patent Application Publication
(10) Pub. No.: US 2003/0146662 A1
(43) Pub. Date: Aug. 7, 2003

(54) Skid track

(76) Inventor: Alois Johann Haringer, Neumarkt (BZ) (IT)

Correspondence Address: FASSE PATENT ATTORNEYS, P.A., P.O. BOX 726, HAMPDEN, ME, 04444-0726, US

(21) Appl. No.: 10/139,150

(22) Filed: May 2, 2002

(30) Foreign Application Priority Data
Feb. 7, 2002 (DE) 102 05 126.7

(51) Int. Cl. B62D 55/14

(52) U.S. Cl. 305/139

(57) ABSTRACT

The invention relates to a skid track having equipment for a construction vehicle and, in particular, a vehicle (skid track) having a bucket 2 serving simultaneously for loading, said vehicle comprising a drive motor and a chassis 3 with a vehicle frame 4. On the vehicle frame 4, in each case running gear 5 with a driveable chain 6 is arranged at the side. For the chains 6, in each case a front guide and deflection wheel 7 at the bottom and a rear guide and deflection wheel 8 and also a third guide and deflection wheel 9 arranged at a higher level are provided. On both sides of the vehicle, in each case at least one of the two deflection wheels arranged at the bottom and serving simultaneously as guide and deflection wheels 7 and 8 has a sprocket 10, which engages in the chain 6 and can be connected to the drive motor.

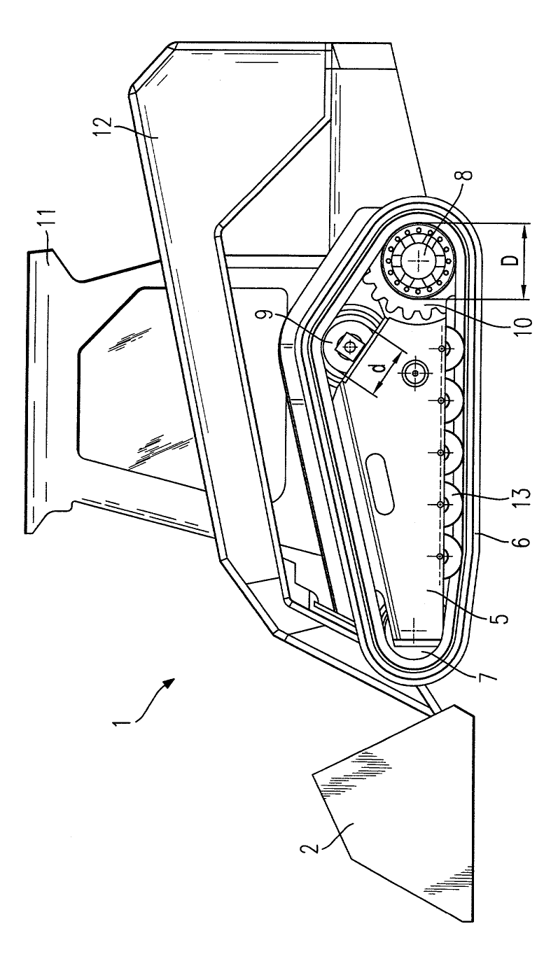

The invention relates to a skid track and, in particular, a vehicle having the features of a wheeled loader on a chassis.

Skid tracks of the type mentioned have been known for a long time. With equipment for a construction vehicle, they can have, for example, a bucket serving simultaneously for loading. Furthermore, in principle a drive motor and a chassis with a vehicle frame are provided, on which in each case running gear with a driven chain is arranged at the side. In order to guide and to deflect the chains, in each case a front guide and deflection wheel at the bottom and a rear guide and deflection wheel are provided and, in addition, a third guide and deflection wheel arranged at a higher level can be used to give the chain a greater length than is absolutely necessary. This is associated with relatively lower wear of the chains.

However, in the case of the known skid tracks of the aforementioned type, it is a problem that the sprockets associated with the third guide and deflection wheel and transmitting the drive forces to the chains wear relatively quickly. The invention is therefore based on the object of providing measures with the aid of which the lifetime of the sprockets may be increased.

In order to achieve this object, the invention provides that, on both sides, in each case at least one of the two wheels arranged at the bottom and serving simultaneously as guide and deflection wheels comprises a sprocket with engages in the chain and can be connected to the drive motor.

The use of guide and deflection wheels arranged at the bottom for the travel drive of the skid track leads to a force distribution to more teeth and therefore to a lower loading and to lower wear on the individual teeth of the two sprockets and, accordingly, also to lower loading and lower wear on the individual chain links of the chain. The reason for this is that the wrap angle of the chains and therefore the number of chain teeth in engagement with the chain is greater in the case of a sprocket arranged at the bottom than in the case of a sprocket which is arranged at a higher level. There, the wrap angel may be only approximately half as great, so that the percentage proportion of the teeth in engagement is also considerably lower.

In development of the invention, provision is further made that the diameter of the sprockets transmitting the drive forces ins additionally greater than the diameter of the other guide and deflection wheels having only a guiding and deflection function. By means of this measure, the wrap angle in the region of the sprocket is additionally somewhat greater, with the consequence that a still greater percentage proportion of the teeth contributes to the force transmission. Primarily, however, the arc length is increased by the greater diameter and permits the arrangement of further teeth. This has an advantage effect in avoiding wear.

The invention will be descriped in more detail below using an exemplary embodiment, which is illustrated in the drawing.

The single FIGURE shows a skid track 1 having equipment for a construction vehicle and, in particular, a vehicle with a tool serving simultaneously for loading in the shape of a bucket 2. A drive motor belongs to the skid track 1. It further comprises a chassis 3 with a vehicle frame 4, on which in each case running gear 5 with a driven chain 6 is arranged at the side. For the chain 6, in each case a front guide and deflection wheel 7 at the bottom and a rear guide and deflection wheel 8 and also a third guide and deflection wheel 9 arranged at a higher level are provided. The chain 6 therefore has three deflection points and, accordingly, three straight chain pieces between them.

In order to transmit the drive forces (such as from a hydraulic motor) to the chains 6, one guide and deflection wheel 8 at the bottom is at the same time provided with a sprocket 10. This sprocket 10 engages in the chain 6 in order to transmit force. The guide and deflection wheel 8 is the rear wheel of the respective chain 6, which can consist of rubber or steel.

As the single FIGURE further reveals, the diameter D of the combined guide and deflection wheel and sprocket 8 is considerably greater than the corresponding reference diameter d of the other two guide and deflection wheels 7 and 9. The radii of the chain 6 at the two deflection points of the front guide and deflection wheel 7 and of the third guide and deflection wheel 9 are therefore correspondingly smaller than on the rear guide and deflection wheels 8 having the sprockets 10.

Both the arrangement of the sprockets 10 in the area of the rear guide and deflection point of the chains and their considerably greater diameter as compared with the corresponding reference diameter of the other guide and deflection wheels have the effect of reducing the wear of the teeth on the sprockets, so that these are valuable measures in this case.

Finally, it goes without saying that the skid track 1 illustrated in the single FIGURE has a large number of further components, such as a driver's cab 11 and a carrier 12 which can be moved in the vertical direction for the bucket 2, and actuating elements for the bucket 2. Supporting rollers 13 are also provided and are likewise known, as are the other components last mentioned above. However, these and further components do not matter, so that in this regard a more detailed description can be dispensed with.

In principle, the same also applies to measures for changing the track width with, for example, two standard widths, and/or to springing between the vehicle frame and the chassis.

1. A skid track having equipment for a construction vehicle, in particular a vehicle having a bucket (2) serving simultaneously for loading, said vehicle comprising a drive motor and a chassis (3) with a vehicle frame (4), on which in each case running gear (5) with a drivable chain (6) is arranged at the side, for which in each case a front guide and deflection wheel (7) at the bottom and a rear guide and deflection wheel (8) and also a third guide and deflection wheel (9) arranged at a higher level are provided,
wherein on both sides in each case at least one of the two deflection wheels arranged at the bottom and serving simultaneously as guide and deflection wheels (7, 8) has a sprocket (10), which engages in the chain (6) and can be connected to the drive motor.

2. The skid track as claimed in claim 1, wherein the driven sprocket (10) which engages in the chain (6) and serves simultaneously as a guide and deflection wheel (8) for the chain (6) has a diameter (D) which is greater than the diameter (d) of the other guide and deflection wheels (7, 9) of each chain (6).
